(19) United States
(12) Patent Application Publication
(10) Pub. No.: US 2008/0278770 A1
(43) Pub. Date: Nov. 13, 2008

(54) Image processing apparatus, computer program product, and image processing method

(75) Inventors: Yoshifumi Sakuramata, Tokyo (JP); Iwao Saeki, Kanagawa (JP); Tetsuya Sakayori, Tokyo (JP); Junichi Takami, Kanagawa (JP); Takashi Yano, Tokyo (JP); Haruo Shida, Kanagawa (JP); Takanori Nagahara, Kanagawa (JP); Hiroko Mano, Tokyo (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/149,210

(22) Filed: Apr. 29, 2008

(30) Foreign Application Priority Data
May 10, 2007 (JP) 2007-125862

(51) Int. Cl. H04N 1/40

(52) U.S. Cl. 358/448

(57) ABSTRACT

Upon receipt of image data of a set of originals in different formats, image analysis information for the image data is generated based on features extracted from the image data. Based on the image analysis information, the formats of the image data is adjusted to a uniform output format. A preview image is created from the image data in the uniform output format. Depending on contents of the preview image, the image data in the uniform output format are output.

### CROSS-REFERENCE TO RELATED APPLICATIONS

The present application claims priority to and incorporates by reference the entire contents of Japanese priority document, 2007-125862 filed in Japan on May 10, 2007.

### BACKGROUND OF THE INVENTION

1. Field of the Invention

The present invention relates to an image processing apparatus, a computer program product, and an image processing method.

2. Description of the Related Art

In recent years, various functions are available in image processing apparatuses such as copiers, facsimile machines, printers, and multifunction products (MFPs) that combine any or all functions of these.

In such an image processing apparatus, a user can specify settings of various functions such as those concerning state of an original including the type and density of the original, those concerning image processing including expansion/reduction ratio, simplex/duplex printing, and margin size, and those concerning finishing including stamping, stapling, and punching.

The user can also specify settings of, not only simplex/duplex printing, various output formats such as a book format for printing image data of one page on both sides of sheets and stapling an edge of the sheets, and a magazine format for stapling sheets in the center like a weekly magazine.

When a set of originals having text and images printed thereon are scanned and printed, the set may include not only A4 portrait originals but those in a plurality of formats. For example, the set may include originals having different sizes such as B4, originals printed in different directions such as A4 landscape originals, originals obtained by combination printing of two-page images on one side of the A4 portrait originals, and originals obtained by printing two-page images each on either side of the originals.

Japanese Patent Application Laid-Open Nos. 2004-140802 and 2006-253973 discloses an image processing apparatus that can collectively scan a set of originals in a plurality of formats. Japanese Patent Application Laid-Open No. 2004-140802 discloses an image processing apparatus that can collectively scan a set of originals including one-side and two-side printed originals and a set of originals in different sizes such as A4 size and A3 size. Japanese Patent Application Laid-Open No. 2006-253973 discloses an image processing apparatus that recognizes images of originals of different combined formats one by one, and thereby outputs even such originals in the same format.

However, even if a set of originals in a plurality of formats can be collectively scanned as described above, there are problems yet to be solved.

Described below is settings of various output formats such as book format and magazine format. Such various output formats are set independently of original data. Therefore, even when data of the same output format are desired, setting items for processing images vary depending on the format of original data. For example, even setting items for processing the same images produce different output results depending on whether originals are one-side printed or two-side printed. Besides, there are an original having one page printed on one side and a set of originals like a book. For combination printing of these originals, setting items for processing the images also vary.

For example, it is assumed that originals are copied from a magazine. On one side of this original, two pages of the magazine are printed. When the originals are output in magazine format by stapling them in the center like a weekly magazine, settings other than that of the magazine format are necessitated. For example, setting work is required for separately arranging pages of the originals. When two pages are printed on both sides of an original, respectively, it is unnecessary to perform such setting work.

As described above, a set of originals includes those in a plurality of formats requires complicated settings for image processing corresponding to the output format. Therefore, an intended output result may not be obtained because of wrong or erroneous print settings.

### SUMMARY OF THE INVENTION

It is an object of the present invention to at least partially solve the problems in the conventional technology.

According to an aspect of the present invention, there is provided an image processing apparatus including an input unit that receives image data of a set of originals in a plurality of formats; an analyzing unit that analyzes the image data to extract a feature of the image data, and generates analysis information for the image data based on the feature; a format display unit that selectably displays output formats for the image data; a selecting unit that allows selection of one of the output formats; an adjusting unit that adjusts, based on the analysis information, the formats of the image data into a uniform output format selected by the selecting unit; a preview creating unit that creates a preview image from the image data in the uniform output format; a preview display unit that displays the preview image; and an output unit that outputs, depending on content of the preview image, the image data in the uniform output format.

According to another aspect of the present invention, there is provided an image processing method that includes receiving image data of a set of originals in a plurality of formats; analyzing the image data to extract a feature of the image data, and generating analysis information for the image data based on the feature; selectably displaying output formats for the image data; selecting one of the output formats; adjusting, based on the analysis information, the formats of the image data into a uniform output format selected at the selecting; creating a preview image from the image data in the uniform output format; displaying the preview image; and outputting, depending on content of the preview image, the image data in the uniform output format.

According to still another aspect of the present invention, there is provided a computer program product that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of an image forming system according to a first embodiment of the present invention;

FIG. 2 is a schematic side view of a scanner shown in FIG. 1;

FIG. 3 is an example of a preview image;

FIG. 4 is an example of a preview image in which a setting item is selected;

FIG. 5 is an example of an association table of setting items and positions where the respective setting item can be set;

FIG. 6 is an example of a preview image subjected to punching;

FIG. 7 is a flowchart of format unifying processing performed under the control of a system control unit shown in FIG. 1;

FIG. 8 is an example of an input screen on which a list of output formats are displayed;

FIG. 9 is a detailed flowchart of image analysis processing shown in FIG. 7;

FIG. 10 is an example of a conversion table T1;

FIG. 11 is an example of a conversion table T2;

FIG. 12 is another example of a preview image;

FIG. 13 is a flowchart of format unifying processing according to a second embodiment of the present invention;

FIG. 14 is a detailed flowchart of image analysis processing shown in FIG. 13; and

FIG. 15 is an example of a conversion table T3.

### DETAILED DESCRIPTION OF THE PREFERRED EMBODIMENTS

Exemplary embodiments of the present invention are explained in detail below with reference to the accompanying drawings.

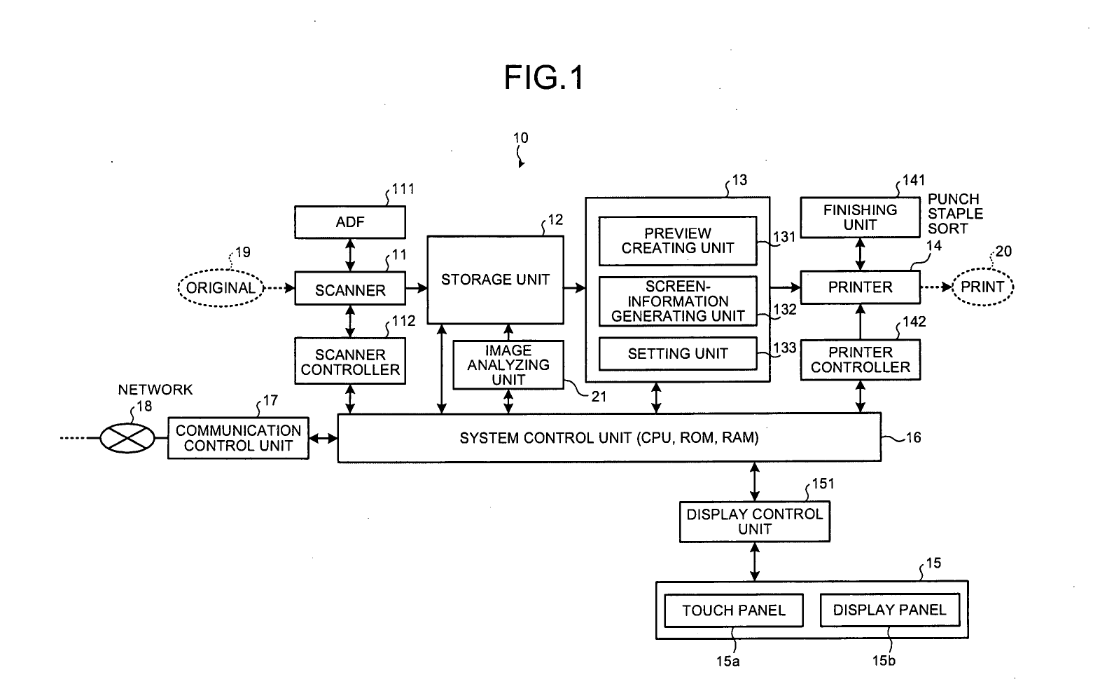

A first embodiment of the present invention is explained referring to FIGS. 1 to 12. An image processing apparatus is explained below as, for example, a multifunction product (MFP) that combines any or all of such functions as a copier, a facsimile (FAX) machine, a printer, a scanner, and a function of delivering an input image (an original image scanned by the scanner or an image input by the FAX machine).

FIG. 1 is a functional block diagram of an MFP 10 according to the first embodiment. The MFP 10 includes a scanner 11, an automatic document feeder (ADF) 111, a scanner controller 112, a storage unit 12, an image processing unit 13, a printer 14, a printer controller 142, a finishing unit 141, a display unit 15, a display control unit 151, a system control unit 16, a communication control unit 17, and an image analyzing unit 21. The MFP 10 is connected to a network 18 via the communication control unit 17. The MFP 10 scans an image of an original 19, applies image processing to the image, and outputs the image as a print 20.

The system control unit 16 is connected to the respective units and controls the MFP 10. For example, the system control unit 16 provides the scanner 11 with scanning area information appropriate for a selected sheet size. The system control unit 16 includes a central processing unit (CPU), a read only memory (ROM), and a random access memory (RAM). The CPU executes a computer program stored in the ROM using a work area of the RAM, thereby performing various types of processing.

The computer program executed on the MFP 10 can be stored in a computer readable recording medium such as a compact disk-read only memory (CD-ROM), a flexible disk (FD), a compact disk-recordable (CD-R), or a digital versatile disk (DVD) as a file of an installable format or an executable format. In this case, the CPU of the system control unit 16 loads the computer program from the recording medium into a main storage (not shown) and execute it, thus implementing various functions of the MFP 10. The computer program can be stored in a computer connected via the network 18 such as the Internet, and downloaded therefrom. The computer program can also be distributed through the network 18.

The communication control unit 17 is connected to a network such as a local area network (LAN) or the Internet and exchanges image data, control data, and the like with other apparatuses connected to the network according to a communication protocol. In other words, the communication control unit 17 has functions of inputting and outputting an image.

The scanner controller 112 receives a command from the system control unit 16 and controls the scanner 11.

The scanner 11 is controlled by the scanner controller 112 and converts an image of the original 19 into digital image data. The ADF 111 sequentially delivers a plurality of pages of originals set thereon to a scanning position of the scanner 11 one by one. Thus, the scanner 11 can automatically and sequentially scan the originals. The ADF 111 can deliver not only an original printed on one side thereof but also an original printed on both sides thereof by reversing the original. Thus, it is possible to cause the scanner 11 to scan the both sides of the original.

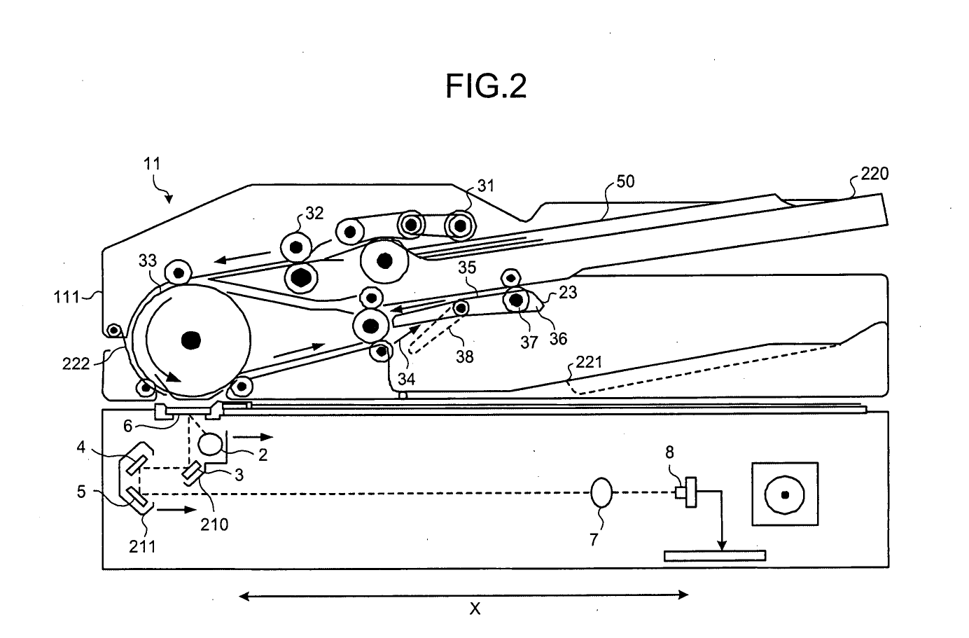

FIG. 2 is a schematic side view of the scanner 11. As shown in FIG. 2, the ADF 111 is used under sheet-scanning modes for scanning, when originals 50 automatically fed from the ADF 111 passes over an exposure glass 6, an image of the original. In such sheet-scanning modes, a first carriage 210 including a lamp 2 and a mirror 3 and a second carriage 211 including two mirrors 4 and S are stopped in home positions below the exposure glass 6. An original automatically fed by the ADF 111 is scanned. Such an operation mode can be set by the display unit 15.

The ADF 111 includes a stand 220 for placing the originals 50 when the originals 50 are scanned in the sheet-scanning modes, a discharging unit 221 for discharging the scanned originals 50, a conveying path 222 communicatively connected from the stand 220 to the discharging unit 221, and a reversing unit 223 that reverses the originals 50 in duplex scanning mode. The duplex scanning mode is one of sheet-scanning modes and is operation mode for automatically feeding the originals 50 with the ADF 111 and scanning an image on the front side thereof and, then, reversing the originals 50 and scanning an image on the rear side thereof.

The stand 220 is provided with an original guide (not shown) that guides both side edges of the originals 50 when the originals 50 placed on the stand 220 are conveyed to the conveying path 222. Sensors (not shown) are also provided such as the one that detects, when the originals 50 are scanned in the sheet-scanning modes, whether the originals 50 are placed on the stand 220, the one that detects the size of the originals 50 placed on the stand 220, and the one that detects trailing edge of the originals 50. In the sheet-scanning modes, even when the size of originals is not designated by key operation or the like, the size of originals placed on the stand 220 is automatically detected by these sensors.

On the stand 220 side of the conveying path 222, a pickup roller 31 and conveying rollers 32 for separating the originals 50 placed on the stand 220 one by one and feeding the originals 50 are provided. The pickup roller 31 and the conveying rollers 32 are driven by a feed motor (not shown). When the pickup roller 31 and the conveying rollers 32 are driven to rotate by the feed motor, the originals 50 placed on the stand 220 are fed to the conveying path 222 one by one.

A conveying drum 33 for conveying the originals 50 and conveying the originals 50 to the discharging unit 221 is also provided in the conveying path 22. The exposure glass 6 is located below the conveying drum 33. The conveying drum 33 is driven by a stepping motor (not shown). Therefore, the originals 50 fed from the stand 220 to the conveying path 222 are guided on the exposure glass 6 when the conveying drum 33 is driven to rotate by the stepping motor.

The originals 50 are picked up from the stand 220 by the pickup roller 31 to be fed one by one and conveyed to the exposure glass 6 in an original scanning position by the conveying rollers 32 and the conveying drum 33.

In the reversing unit 223, a reversing table 36 that forms a reversing path 35, one end of which is communicatively connected to a branching point 34 branching from the conveying path 222, is provided. The reversing table 36 is provided with reversing rollers 37 driven to freely rotate in opposite directions by a feed and reverse motor (not shown). A branching pawl 38 pivotable around a support shaft is attached to the reversing path 35. The branching pawl 38 opens and closes the reversing path 35 with respect to the conveying path 222 according to the pivoting of the support shaft to thereby branch the originals 50, which are conveyed by the conveying drum 33, to one of the reversing unit 223 and the discharging unit 221. Under the setting of the duplex scanning mode that is one of the sheet-scanning modes, the branching pawl 38 opens the reversing path 35 with respect to the conveying path 222 according to the pivoting of the support shaft and guides the originals 50, which are conveyed by the conveying drum 33, to the reversing path 35. The reversed originals 50 are conveyed to the conveying path 222 again by the reversing rollers 37.

Original feeding and conveying operation in the sheet-scanning modes and original reversing operation can be performed by a known technology, and therefore, a detailed explanation thereof is not deemed necessary herein.

Each of the originals 50 set on the original placing stand 220 is sent to the exposure glass 6 in the original scanning position by the conveying rollers 32 and the conveying drum 33. Before original scanning is started, the lamp 2 of the first carriage 210 is turned on and the light of the lamp 2 is condensed by a reflector and irradiates an original surface. The light radiated from the lamp 2 of the first carriage 210 is reflected on the original 50 and made incident on a color CCD 8 through the three mirrors 3, 4, and 5 and the lens 7. The original 50 is sent at constant speed according to the rotation of the conveying drum 33 and one side of the original 50 is scanned by the color CCD 8. The original 50 subjected to scanning processing by the color CCD 8 is discharged to the discharging unit 221 according to the rotation of the conveying drum 33. Thereafter, the originals 50 placed on the stand 220 are sequentially scanned.

The storage unit 12 is a buffer memory that receives a command from the system control unit 16 and temporarily stores therein image data scanned by the scanner 11, image data received from the outside through the network 18, and the like. The MFP 10 can process image data received from the outside through the network 18 as well as image data scanned by the scanner 11 to form an image. The storage unit 12 also stores therein image data processed by the image processing unit 13.

The image processing unit 13 receives a command from the system control unit 16, applies γ correction, modulation transfer function (MTF) correction, and the like to multi-value data sent from the scanner 11 and temporarily stored in the storage unit 12. The image processing unit 13 performs gradation processing such as slicing and dithering on the data, and converts it to digital (multi-value) data. The image processing unit 13 performs various kinds of image processing (reduce/enlarge, adjustment of density and colors, etc.) corresponding to functions set by a user, image-area edit (area erasure, area movement, area reversal, etc.), and layout processing (duplex/simplex printing, image combining, margin adjustment, etc.). Thus, the image processing unit 13 creates a preview image indicating a finished state of an image.

The image processing unit 13 includes a preview creating unit 131, a screen-information generating unit 132, and a setting unit 133.

Basically, the preview creating unit 131 creates a preview of the original image (a preview image) based on settings or parameters specified for processing image data obtained by pre-scanning an original image and displayed on a display panel 15b. The preview creating unit 131 uses the multi-value data temporarily stored in the storage unit 12.

The screen-information generating unit 132 generates input screen information displayed on the display panel 15b. The input screen information includes the preview image and various types of setting items for the preview image created by the preview creating unit 131.

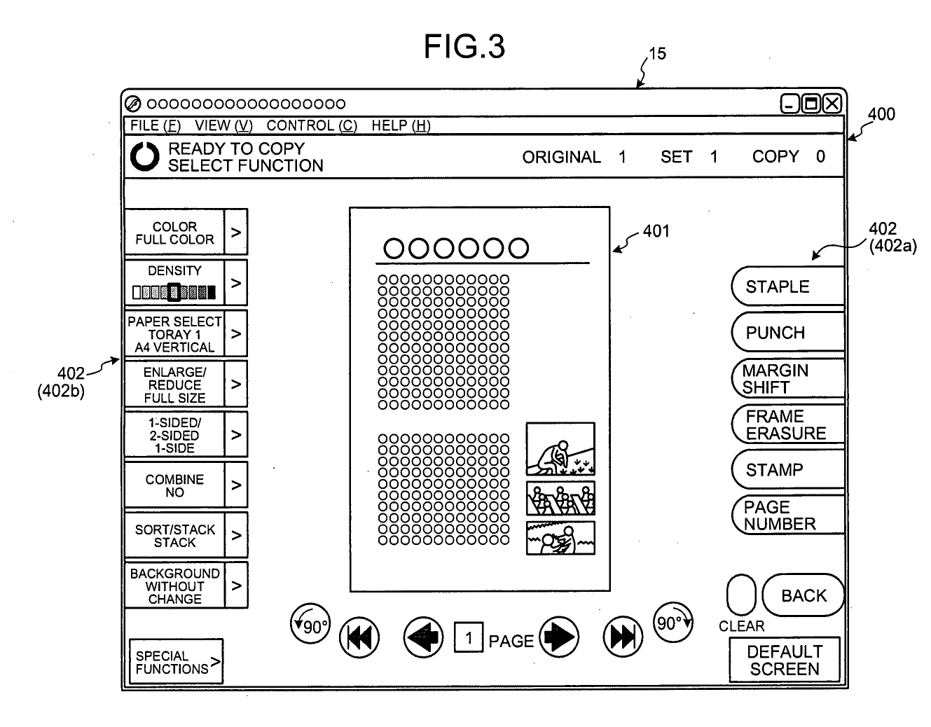

When the user provides setting input on an input screen 400 (refer to FIG. 3) displayed on the display panel 15b through a touch panel 15a, described later, the setting unit 133 receives a signal of the setting input and acquires coordinate information concerning an input image stored in the storage unit 12. The setting unit 133 sets processing corresponding to the acquired coordinate information in the screen-information generating unit 132.

When the setting unit 133 receives a setting input signal, the preview creating unit 131 updates and creates a preview image again according to the setting input signal and outputs the preview image to the screen-information generating unit 132. The screen-information generating unit 132 generates input screen information to display a screen for receiving a setting input from the user again according to the setting input signal received by the setting unit 133, and outputs the input screen information to the display control unit 151.

The display control unit 151 receives a command from the system control unit 16 and controls input and output of the display unit 15. For example, the display control unit 151 controls to output data processed by the image processing unit 13 to the touch panel 15a and the display panel 15b. More specifically, the display control unit 151 causes the display panel 15b to display a preview image. The display control unit 151 controls input from the touch panel 15a. The display panel 15b and the touch panel 15a are separately shown in FIG. 1; however, they are explained as being integrated in the following description.

The touch panel 15a detects a position with which a pointer makes an electric or magnetic contact. As pointing means (not shown) for pointing a position on the touch panel 15a, a finger tip, a stylus pen, and other touch input tools (hereinafter, “pointers”) can be used. The user inputs various settings or parameters including print setting by touching the touch panel 15a with such a pointer.

In the first embodiment, an example is explained in which input is provided by touching the touch panel 15a. However, input can be provided in other manners. For example, the display unit 15 can include a hard key (physical key) that a user presses to issue a command such as a print command. As the display panel 15b, a dedicated display device included in the MFP 10 can be used.

The display unit 15 displays functions available in the MFP 10 as setting items and receives from the user setting input indicating a setting item selected from the setting items. When a user touches with the pointer a position on the touch panel 15a, a coordinate of the position is detected. When the position is in an area corresponding to a setting item (where the setting item is selectable), the display control unit 151 determines that the setting item is selected. For example, the display unit 15 receives setting of scanning conditions for the scanner 11 corresponding to the state of an original, setting for the image processing unit 13 that performs processing such as image quality adjustment on scanned image data, setting of print conditions for the printer 14, and setting for the finishing unit 141 that applies finishing such as sorting, stapling, and punching to a print after printing.

The printer controller 142 controls the printer 14 in response to a command from the system control unit 16.

The printer 14 is mounted with the finishing unit 141. The finishing unit 141 performs finishing, based on automatic setting or setting specified by the user, such as sorting, by a unit of the number of copies or a page, the print 20 obtained by printing, stamping a predetermined stamp on a print medium, aligning a plurality of print media and stapling the print media, and punching punch holes for binding the print media in a binder or a file.

Upon receiving a setting as described above via the display control unit 151, the system control unit 16 causes the image processing unit 13 to create a preview image by reflecting the setting on the original image data stored in the storage unit 12. The system control unit 16 sends the preview image to the display unit 15 such that the display unit 15 displays the preview image.

FIG. 3 is an example of a preview image created by the preview creating unit 131 from input image data. A preview image 401 and setting items 402 are displayed on the display panel 15b. As the setting items 402, a menu 402a related to positions or an original direction on the preview image 401 including items such as staple, punch, margin shift, frame erasure, stamp, and page number is displayed on the right side of the screen. On the left side of the screen is displayed menu 402b not related to contents of image data, such as an output color, output density, sheet, reduce/enlarge, simplex/duplex, combination, sort and stack, and background. In other words, the menu 402b includes setting items for functions that can be specified without checking an original image.

When the user touches the touch panel 15a with the pointer while viewing the preview image 401 displayed on the display panel 15b, the touch panel 15a receives input of positional information concerning a spatial position on a print in a finished state displayed as the preview image 401. In such a case, the setting unit 133 analyzes the positional information received through the touch panel 15a and acquires coordinate information indicating a position or points on an image touched by the pointer.

The image analyzing unit 21 performs image analysis processing on image data stored in the storage unit 12 and analyzes the feature of the image data. For example, the image analyzing unit 21 analyzes how pages are arranged in image data, whether image data is subjected to column setting, and whether image data can be divided.

The image analyzing unit 21 analyzes, as a feature of an image, how contents, i.e., one or more pages, of image data are arranged with respect to original surfaces or the state of the image data. Specifically, for example, the image analyzing unit 21 analyzes whether image data is printed only on one side or on both sides of a sheet, or a plurality of pages of image data is printed on a side of a sheet. The arrangement of image data indicates which part of a sheet image data is printed. In the case of two-side printed original, the arrangement of image data also includes arranging direction of the image data on the front and rear sides.

In the image analysis processing, such a feature is extracted and digitized from an image to calculate a feature value. Specifically, information is obtained such as image-data size, printing side of image data, printing area of image data, printing-area size, colors in use, printing density, direction of printing, and arrangement order. Known white detecting function and known image area recognizing function can be applied to the image analysis processing.

With this structure, the MFP 10 displays, prior to printing, the preview image 401 on the display panel 15b. After checking the preview image 401 visually, the user can change the setting when necessary and perform printing.

More specifically, copying can be reliably performed by a series of processes: (1) pre-scanning an original, (2) displaying an image of the original pre-scanned on a screen as a preview image, (3) when a user touches a predetermined position on the preview image, displaying a menu of functions corresponding to the position, (4) when the user selects one of the functions, immediately reflecting the function in the preview image, and, (5) after checking the update preview image on the screen, starting printing.

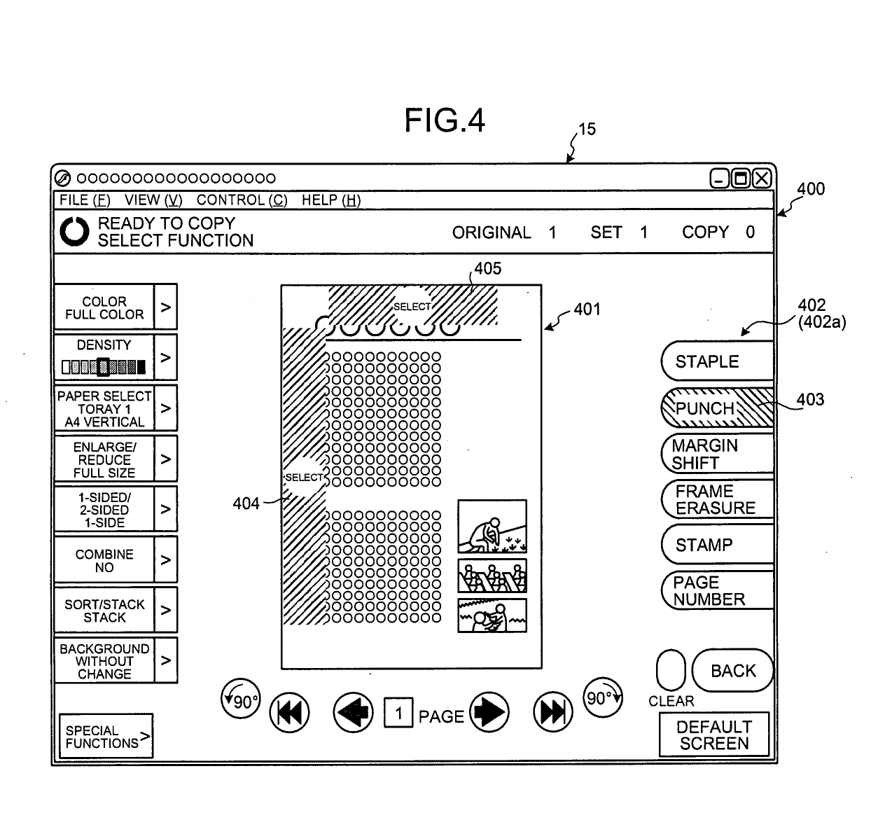

As shown in FIG. 4, it is assumed that punch 403 is selected from the setting items 402 (the menu 402a) displayed on the display unit 15 by touch input from the user.

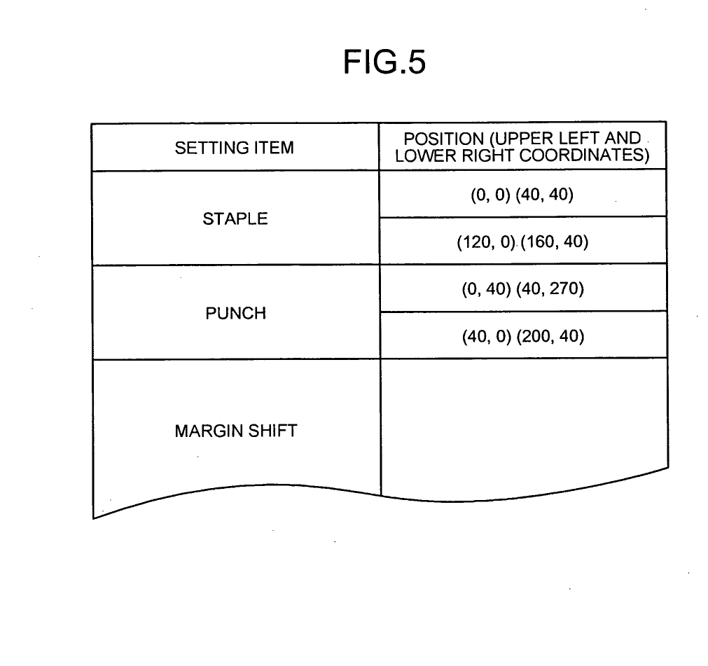

When the display unit 15 detects a touch on the punch 403 displayed thereon, the system control unit 16 receives setting of the punch 403 via the display control unit 151. The screen-information generating unit 132 reads out an area corresponding to the punch 403 from an association table. In the association table, as shown in FIG. 5, functions corresponding to the setting items 402 are associated with areas where the functions is to be applied. The screen-information generating unit 132 displays areas 404 and 405 where the punch 403 can be applied on the display unit 15. Such an association table is stored in RAM or the like of the system control unit 16. The areas 404 and 405 where punch holes can be opened can be displayed on the preview image 401 in an overlaid manner. The areas 404 and 405 can also be displayed with a different color, as being blinking, or with other areas darkening out. The areas indicated by the association table shown in FIG. 5 are defined by a rectangle having sides parallel in main scanning and sub-scanning directions, respectively, defined by diagonal lines each connecting two points defined by coordinates. For example, an area for “staple” is defined by a line from (0,0) to (40,40) and a line from (120,0) to (160,40).

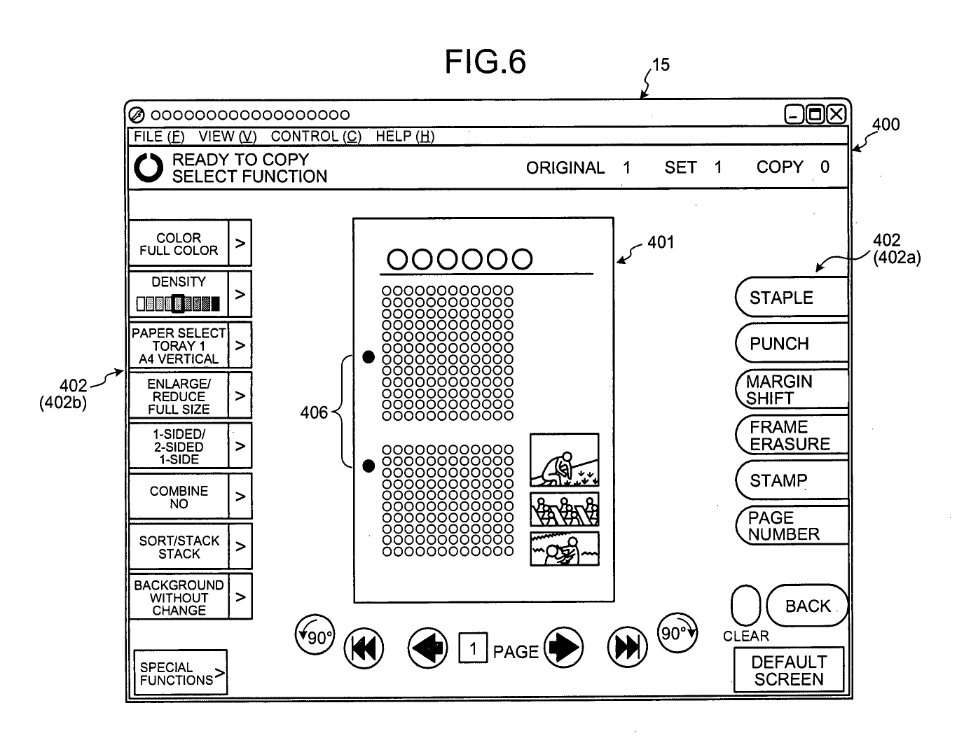

The user provides touch input by touching the punch hole area 404 shown in FIG. 4. The display unit 15 receives the touch input on the punch 403. The preview creating unit 131 creates a preview image by reflecting the setting for applying punching in the area, sends the preview image to the display unit 15. Accordingly, the display unit 15 displays the preview image. The preview image 401 subjected to punching 406 is shown in FIG. 6. Setting input such as correction is received through the preview image 401 displayed in this way. The setting is reflected and displayed again. When there is no setting input, printing is performed.

Although not shown, when the user touches a specific position on the preview image, a menu of functions related to the position can be displayed, such that when a user selects one of the functions, the effect of the function can be immediately reflected in the preview image.

The MFP 10 collectively scans a set of originals in a plurality of formats and selects an output format. The MFP 10 can automatically determine, based on a feature value obtained as an analysis result by the image analyzing unit 21, setting items and setting contents for adjusting image data into, for example, a single-sided standard format (e.g., one-side printed A4 portrait format) as a reference format to output the image data in a uniform output format. A set of originals in a plurality of formats refers to, for example, the set includes not only A4 portrait originals but a mixture of originals in a plurality of formats such as originals having different sizes such as B4, originals printed in different directions such as A4 landscape originals, originals obtained by combination printing of two-page images on one side of the A4 portrait originals, and originals obtained by printing two-page images on both sides of the originals.

Output formats are unified so that image data are output in a uniform output format suitable for use by the user. Examples of output formats include a simplex format for printing image data of one page on only one side for work and distribution, a duplex format for printing image data of one page on both sides, a combined format for combination printing of two-page images on one side, a book format for printing image data for one page on both sides and stapling sheets, and a magazine format for stapling sheets in the center like a weekly magazine.

Thus, even when the MFP 10 collectively scans a set of originals in a plurality of formats, the MFP 10 allows the user to obtain prints in a necessary format with simple operation.

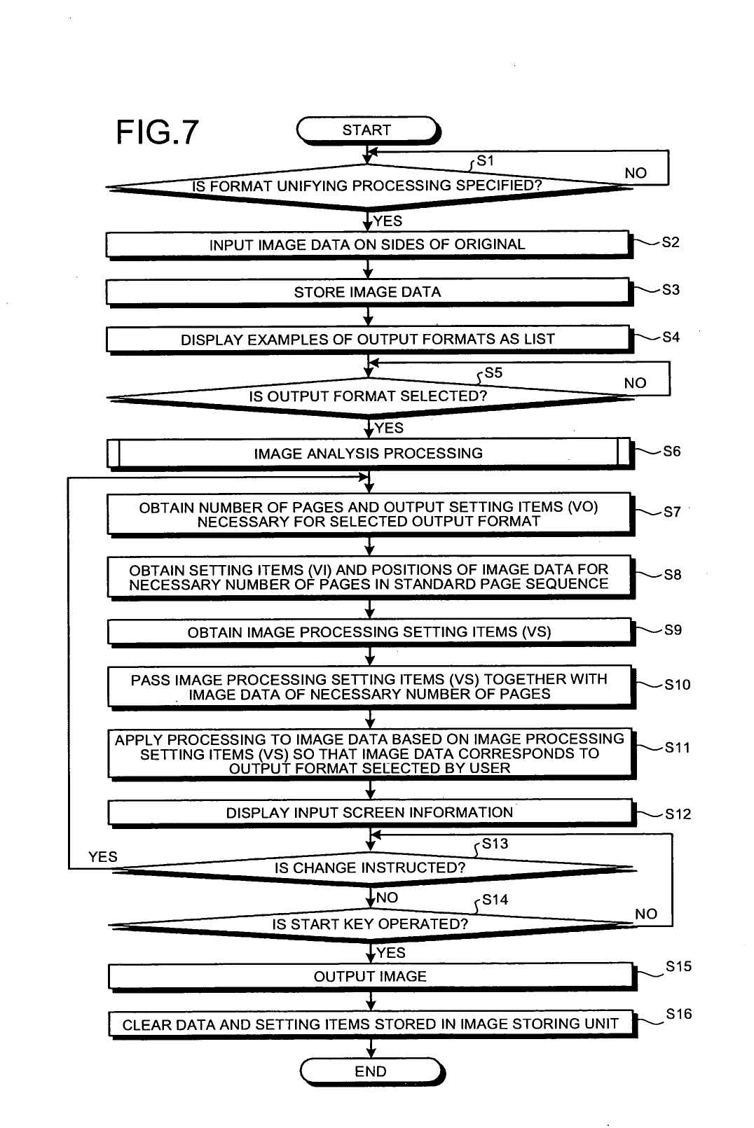

Format unifying processing is performed under the control of the system control unit 16 (the CPU of the system control unit 16 operating based on the computer program stored in the ROM). The format unifying processing is explained below referring to FIG. 7.

The originals 50 in a plurality of formats are placed on the stand 220 of the ADF 111. In this state, as shown in FIG. 7, the system control unit 16 determines that format unifying processing for mixed originals in a plurality of formats is specified by predetermined key operation on the display unit 15 (Yes at step S1). The scanner controller 112 actuates the scanner 11 to acquire image data on both sides of the original 50 (step S2). The system control unit 16 stores the image data scanned by the scanner 11 in the storage unit 12 (step S3).

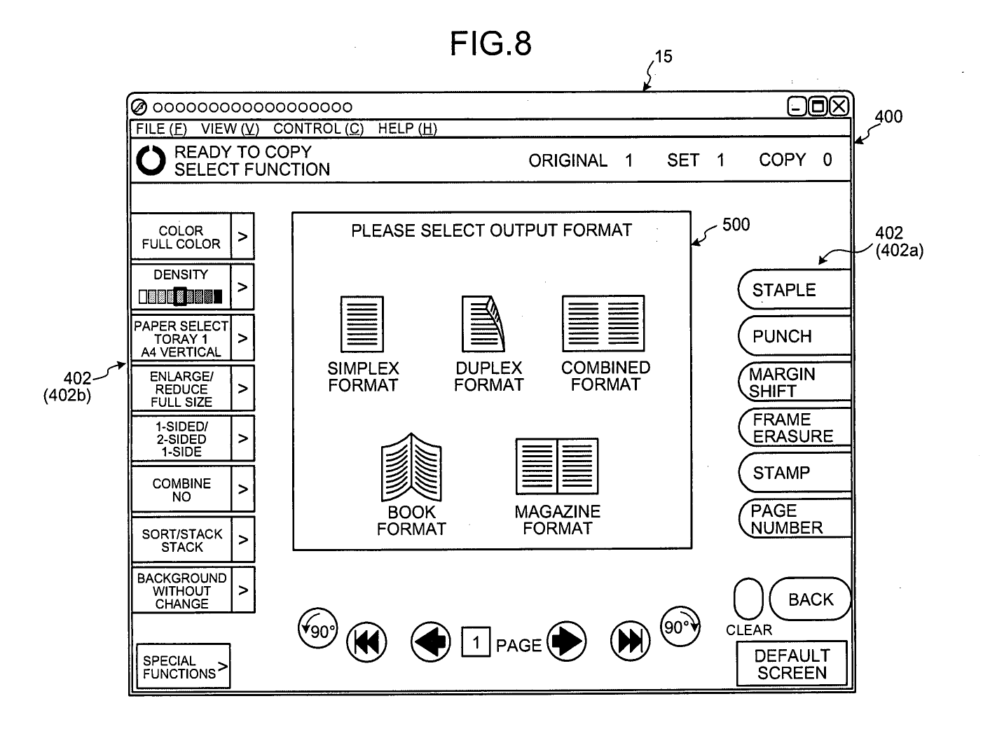

The screen-information generating unit 132 generates input screen information displayed on the display panel 15b (step S4). Available output formats are displayed, for example, as a list. FIG. 8 is an example of the input screen 400 on which a list of output formats is displayed. As shown in FIG. 8, a list screen 500 showing a list of output formats is displayed on the input screen 400.

In the MFP 10, many patterns are available as output formats. For example, in the case of a simplex standard format, there are a plurality of sheet sizes: A3 size, A4 size, B4 size, and B5 size. However, sizes of sheets that can be stored in the MFP 10 are limited. Sizes of filing frequently used by the user are usually determined. Therefore, the number of selection items of the output formats displayed on the display unit 15 is not so large. The items of the output formats can be attached with flags indicating propriety of display such that only necessary ones can be displayed. The screen-information generating unit 132 displays only output formats permitted to be displayed by the setting on the display unit 15 as selected items.

In such a state, the system control unit 16 confirms the completion of acquisition of image data on both sides of all the originals 50 placed on the stand 220 and receives input of an output format selected by the user through the display control unit 151 (Yes at step S5). The image analyzing unit 21 performs image analysis processing on the image data scanned by the scanner 11 and stored in the storage unit 12 (step S6).

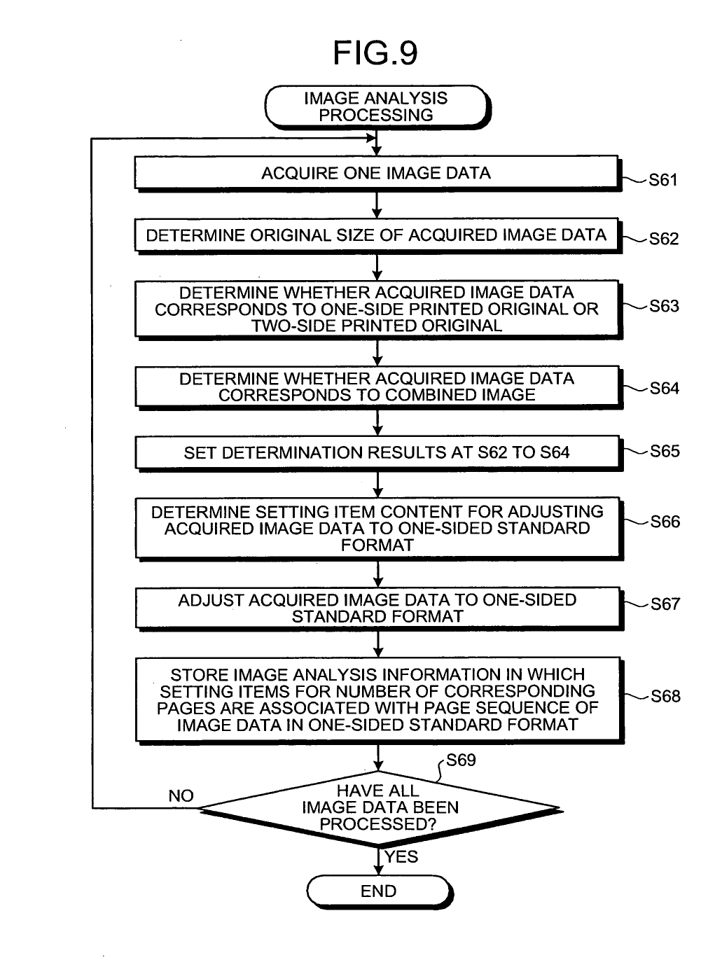

The image analysis processing at step S6 is described in detail referring to FIG. 9. As shown in FIG. 9, the image analyzing unit 21 acquires one image data from the storage unit 12 (step S61). The image analyzing unit 21 determines an original size of the acquired image data (step S62), whether the acquired image data corresponds to one-side printed original or two-side printed original (step S63), and whether the acquired image data corresponds to a combined image, i.e., an image of combined pages (step S64). At step S62, for example, the image analyzing unit 21 can determine the original size from a size of the image data or can receive the original size from the respective sensors provided in the scanner 11 at the time of scanning. Whether the image data corresponds to one-side printed original or two-side printed original can be determined (step S63) in such a manner that, for example, when it is detected by the known white detecting function that the image data is acquired from a white page, the image analyzing unit 21 can determine that image data read immediately before the image data detected as white page corresponds to one-side printed original. The image analyzing unit 21 can determine whether the image data corresponds to a combined image (step S64) by recognizing respective image areas in the image data using the known image area recognizing function. For example, when there is an image area only in a half of image data, it is highly likely that the image data has been obtained by reading an original on which only one page is printed by 2-in-1 combination. In the case of a combined image, the image data also includes the number of combined pages per one side, an arranging direction of the pages, or order of arrangement of the pages. Besides, the image data also includes a size of the image data, colors in use, density, or a type of an image such as text, photograph, diagram, or illustration. This is because, when the image data is of a diagram or an illustration, these data are necessary to determine whether the image data corresponds to a combined image when there are a plurality of contents. For example, when two illustrations are drawn on the left and right, the image analyzing unit 21 determines that the image data is not a text image, and thus not a combined image.

At step S65, the image analyzing unit 21 sets results of the determination made at steps S62 to S64. More specifically, the image analyzing unit 21 sets, in the RAM or the like, the original size (e.g., A4) determined at step S62, one-side printed original or two-side printed original determined at step S63, and the number of combined pages per one side determined at step S64 (e.g., two for 2-in-1 printing).

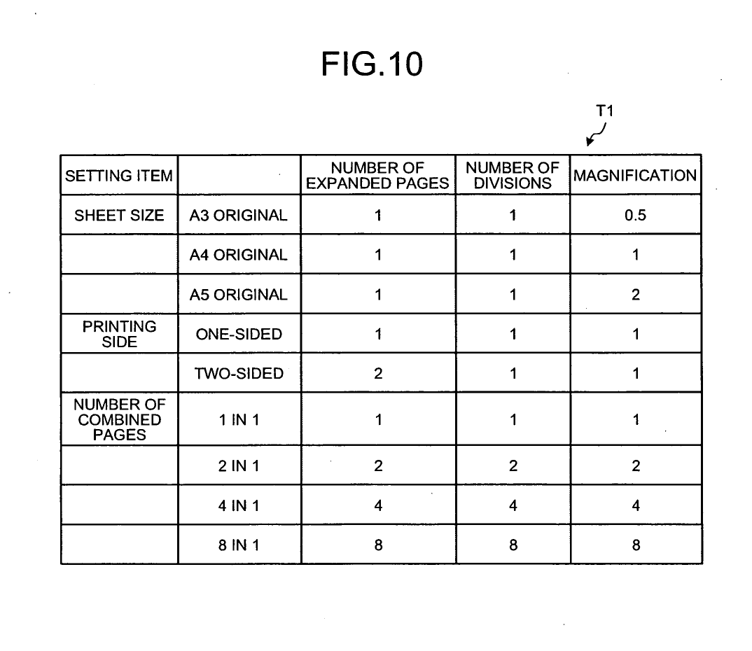

Subsequently, the image analyzing unit 21 determines, based on the determination results obtained at steps S62 to S64, setting item content for adjusting the image data acquired at step S61 to a one-sided standard format (e.g., image data of an A4 portrait one-side printed original) (step S66), and adjusting it to the one-sided standard format (step S67). The image analyzing unit 21 stores, in the storage unit 12, image analysis information in which setting items for the number of corresponding pages (image data) are associated with a page sequence (a standard page sequence) of the image data in the one-sided standard format (step S68). For example, a conversion table T1 as shown in FIG. 10 is used. In the conversion table T1 shown in FIG. 10, the A4 original is set as a standard format. It is possible to determine setting item contents (the number of expanded pages, the number of divisions, and magnification) used in adjusting the image data to the one-sided standard format according to a sheet size, a printing side, and the number of combined pages. For example, when image data is of A3 size, the magnification is set to “0.5” to reduce the size to A4 size. When the number of combined pages is 2, the magnification is set to “2”.

The standard page sequence is explained. For example, two one-side printed originals (A4), one combined-printed original (A3), and one two-side printed original (A4) are scanned by the scanner 11. In this case, since a rear side of the first one-side printed original (A4) is determined as a white page, a page number 1 is allocated to only a front side of the original. Since a rear side of the second one-side printed original (A4) is also determined as a white page, a page number 2 is allocated to only a front side of the original. Since it is analyzed that the combined-printed original (A3) is subjected to combination printing of pages on the left and right thereof, page numbers 3 and 4 are allocated to two divided image data. Since it is analyzed that the two-side printed original (A4) has an image printed on both sides thereof, page numbers 5 and 6 are allocated to the front and rear sides, respectively.

The image analyzing unit 21 performs the processing at steps S61 to S68 on all image data in the storage unit 12 (step S69).

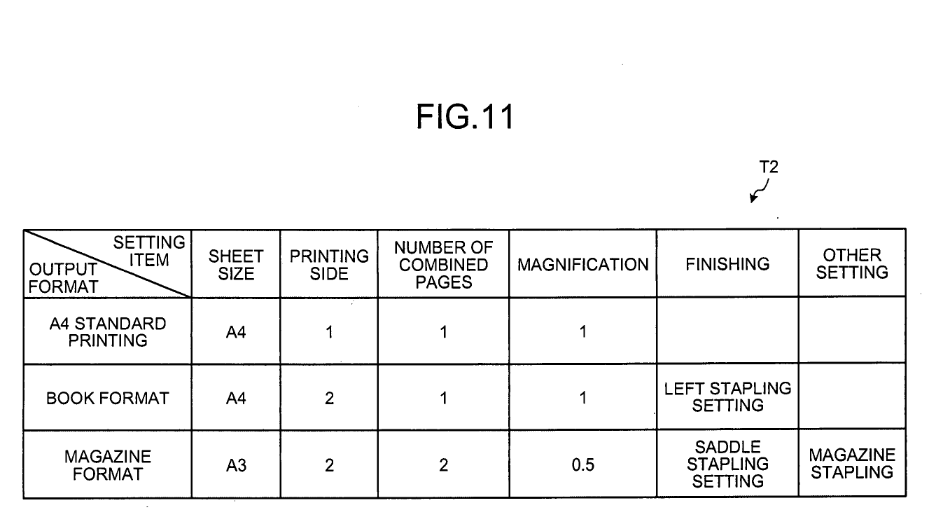

Referring back to FIG. 7, when the image analysis processing at step S6 is finished, the system control unit 16 obtains the number of pages and output setting items (VO) necessary for the output format selected by the user (step S7) using, for example, a conversion table T2 as shown in FIG. 11. In the conversion table T2 shown in FIG. 11, output setting items (sheet size, printing side, the number of combined pages, magnification, finishing, etc.) in changing the one-sided standard format to various output formats can be determined.

The system control unit 16 obtains positions and setting items (VI) of image data for a necessary number of pages in the standard page sequence referring to the image analysis information generated at step S6 (step S8). The system control unit 16 obtains image processing setting items (VS) by combining the setting items (VI) and the output setting items (VO) (step S9) and passes the image processing setting items (VS) to the image processing unit 13 together with the image data of the necessary number of pages (step S10).

Subsequently, the image processing unit 13 applies processing to the image data based on the image processing setting items (VS) so that the image data corresponds to the output format selected by the user, and passes a result of the processing to the storage unit 12 (step S11).

At step S12, the preview creating unit 131 creates a preview image corresponding to the image data processed by the image processing unit 13 and stored in the storage unit 12. The screen-information generating unit 132 generates input screen information from the preview image and the image processing setting items (VS). The display control unit 151 displays the input screen information on the display panel 15b.

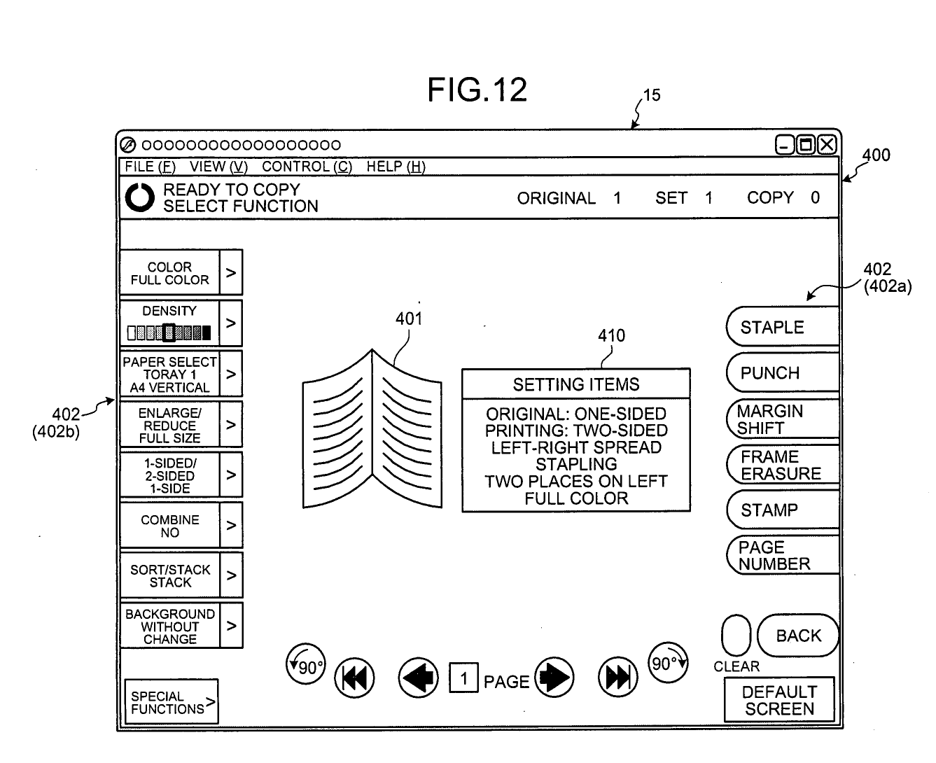

FIG. 12 is another example of the preview image. As shown in FIG. 12, in addition to the preview image 401 and the setting items 402, image processing setting items (VS) 410 obtained from the image analysis information and the selected one output format is displayed on the display panel 15b. In the first embodiment, the setting items (VI) for adjusting image data to the standard format are also included in the image processing setting items (VS) 410. The example shown in FIG. 12 indicates that the book format is selected by the user. Consequently, in reading a set of originals at a time and performing setting processing, when setting is changed according to respective originals, page shift is possible on the preview image 401 to display the preview image 401 of the relevant page, and check the image processing setting items (VS) 410 of the page. Naturally, it is possible to set processing of the page again if necessary. Therefore, it is possible to store, together with a position of an original arranged in the standard page sequence, conversion setting for the original in the standard page sequence.

The user checks whether the setting satisfies his/her requirement while viewing the preview image 401. When the user desires to add or change a setting item, the user provides an instruction for the change from the setting items 402. According to the instruction (Yes at step S13), the system control unit 16 repeats the processing at steps S7 to S11. In other words, when additional setting is specified by the user, the system control unit 16 updates the image processing setting item (VS) 410. The preview image 401 is created and displayed again.

On the other hand, when there is no such instruction and a start key (not shown) of the display unit 15 is operated (Yes at step S14), the printer controller 142 controls the printer 14 to print the processed image based on specified settings (step S15). When, for example, the book format is selected as the output format at step S15, the finishing unit 141 performs stapling for binding the print 20 with staples.

When the print output is finished, the system control unit 16 clears the data and the setting items stored in the storage unit 12 (step S16).

Examples of a print result are explained below. As an example of originals, it is assumed that there are one A4 one-side printed original, one A4 two-side printed original, and one A4 one-side printed original. It is assumed that the duplex format is selected as the output format. When the scanning is performed in the order described above, front sides of the first one-side printed original and the second two-side printed original are printed on the front and rear sides of a first print sheet of a print result. Subsequently, contents of a rear side of the two-side printed original and the last one-side printed original are printed on the front and rear sides of s second print sheet.

For example, it is assumed that there are A4 one-side printed original and B4 two-side printed original. As the output format, it is assumed that the A4 simplex format is selected. When scanning is performed in the order described above, the A4 one-side printed original is directly output.

On the other hand, the B4 two-side printed original is reduced to the A4 size and output as two duplex prints. When the output format is adjusted in this way, it is easy to treat prints when the prints are distributed or stored later.

According to the first embodiment, with respect to image data obtained from a set of originals in a plurality of formats, image analysis information is generated based on the feature of the image data extracted therefrom. The image data of the set of originals are unified into a selected output format based on the image analysis information. A preview image is created from the image data in the output format and is displayed. The image data are output depending on content of the preview image. Thus, even when a set of originals includes those in a plurality of formats (image data in a plurality of formats), it is possible to obtain an output in a desired format by only selecting a desired output format.

In the first embodiment, the one-sided standard format is converted into a selected output format based on the conversion table T2, and then detailed setting is added from the displayed setting items 402 every time when necessary. However, if a user always specifies the same processing settings, the user is likely to wish to register the settings in the conversion table T2. Therefore, the conversion table T2 can be configured such that a user can additionally registers an output format thereto, by, for example, selecting an output format close to the desire one from the conversion table T2 and specifying additional settings. Output formats additionally registered in this manner is displayed in a list on the display panel 15b as examples. For example, when stapling is set for the book format in the conversion table T2, the conversion table T2 can be customized to provide an item of punching for binding. Besides, combined pages can be arranged in facing pages in the same manner as the original or arranged on the front and rear sides of a sheet. As these settings, if a user registers frequently used formats, pages are automatically arranged when rearranged.

As described above, a user can easily customize the conversion table T2 of the standard output format. Since the conversion table T2 is independent of features of an original image, customization of only an output format can be reflected in various original formats.

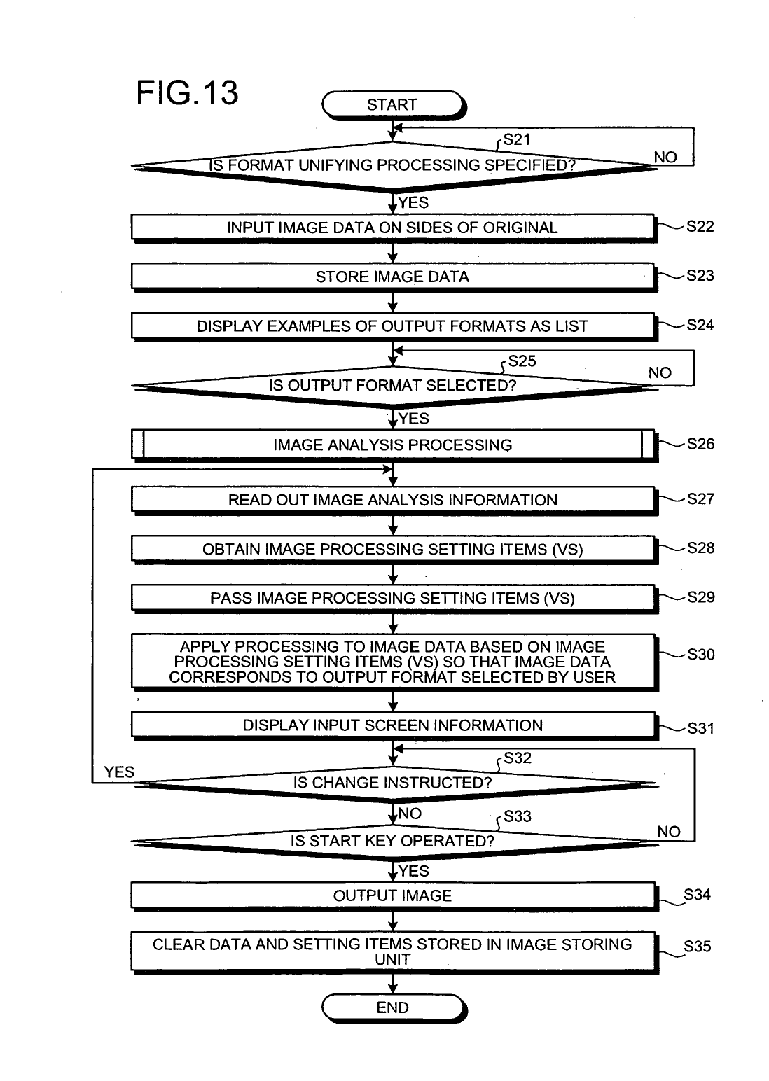

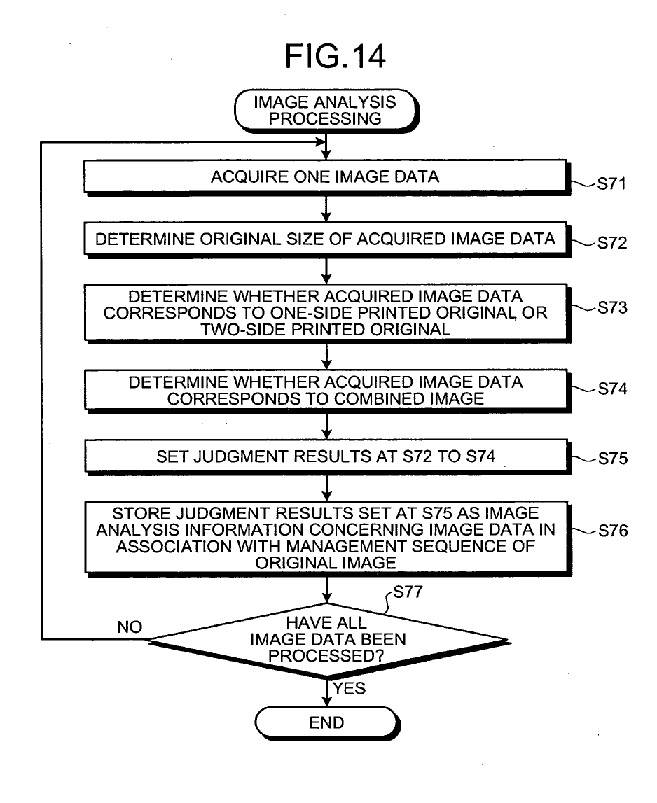

A second embodiment of the present invention is explained below referring to FIGS. 13 and 14. Like reference numerals and signs refer to corresponding components as in the first embodiment, and the same explanation is not repeated.

In the first embodiment, original images are once arranged in the sequence after conversion into the on-sided standard format (the standard page sequence) and are then subjected to output processing. The second embodiment differs from the first embodiment in that the original images are not arranged in the standard page sequence and setting items are set by using a conversion table according to features of formats of the original images subjected to the output processing and output formats.

FIG. 13 is a flowchart of format unifying processing according to the second embodiment. As shown in FIG. 13, the originals 50 in a plurality of formats are placed on the stand 220 of the ADF 111. In this state, as shown in FIG. 13, the system control unit 16 determines that format unifying processing for mixed originals in a plurality of formats is specified by predetermined key operation on the display unit 15 (Yes at step S21). The scanner controller 112 actuates the scanner 11 to acquire image data on both sides of the original 50 (step S22). The system control unit 16 stores the image data scanned by the scanner 11 in the storage unit 12 together with the order of scanning originals as a management sequence for original images (step S23).

The screen-information generating unit 132 generates input screen information displayed on the display panel 15b (step S24). Examples of output formats are displayed, for example, as a list as shown in FIG. 8.

In such a state, the system control unit 16 confirms the completion of acquisition of image data on both sides of all the originals 50 placed on the stand 220 and receives input of an output format selected by the user through the display control unit 151 (Yes at step S25). The image analyzing unit 21 performs image analysis processing on the image data stored in the storage unit 12 and scanned by the scanner 11 (step S26).

The image analysis processing at step S26 is described in detail referring to FIG. 14. As shown in FIG. 14, the image analyzing unit 21 acquires one image data from the storage unit 12 (step S71). The image analyzing unit 21 determines an original size of the acquired image data (step S72), whether the acquired image data corresponds to one-side printed original or two-side printed original (step S73), and whether the acquired image data corresponds to a combined image (step S74). At step S72, for example, the image analyzing unit 21 can determine the original size from a size of the image data or can receive the original size from the respective sensors provided in the scanner 11 at the time of scanning. Whether the image data corresponds to one-side printed original or two-side printed original can be determined (step S73) in such a manner that, for example, when it is detected by the known white detecting function that the image data is acquired from a white page, the image analyzing unit 21 can determine that image data read immediately before the image data detected as white page corresponds to one-side printed original. The image analyzing unit 21 can determine whether the image data corresponds to a combined image (step S74) by recognizing respective image areas in the image data using the known image area recognizing function. For example, when there is an image area only in a half of image data, it is highly likely that the image data has been obtained by reading an original on which only one page is printed by 2-in-1 combination. In the case of a combined image, the image data also includes the number of combined pages per one side, an arranging direction of the pages, or order of arrangement of the pages. Besides, the image data also includes a size of the image data, colors in use, density, or a type of an image such as text, photograph, diagram, or illustration. This is because, when the image data is of a diagram or an illustration, these data are necessary to determine whether the image data corresponds to a combined image when there are a plurality of contents. For example, when two illustrations are drawn on the left and right, the image analyzing unit 21 determines that the image data is not a text image, and thus not a combined image.

At step S75, the image analyzing unit 21 sets results of the determination made at steps S72 to S74. More specifically, the image analyzing unit 21 sets, in the RAM or the like, the original size (e.g., A4) determined at step S72, one-side printed original or two-side printed original determined at step S73, and the number of combined pages per one side determined at step S74 (e.g., two for 2-in-1 printing).

Subsequently, the image analyzing unit 21 stores the determination results set at step S75 as image analysis information concerning the image data in association with the management sequence of original images stored in the storage unit 12 (step S76).

The processing at steps S71 to S76 are performed on all image data in the storage unit 12 (step S77).

Referring back to FIG. 13, when the image analysis processing is finished, the system control unit 16 reads the image analysis information stored in the storage unit 12 together with the order of originals in the management sequence of the original images (step S27).

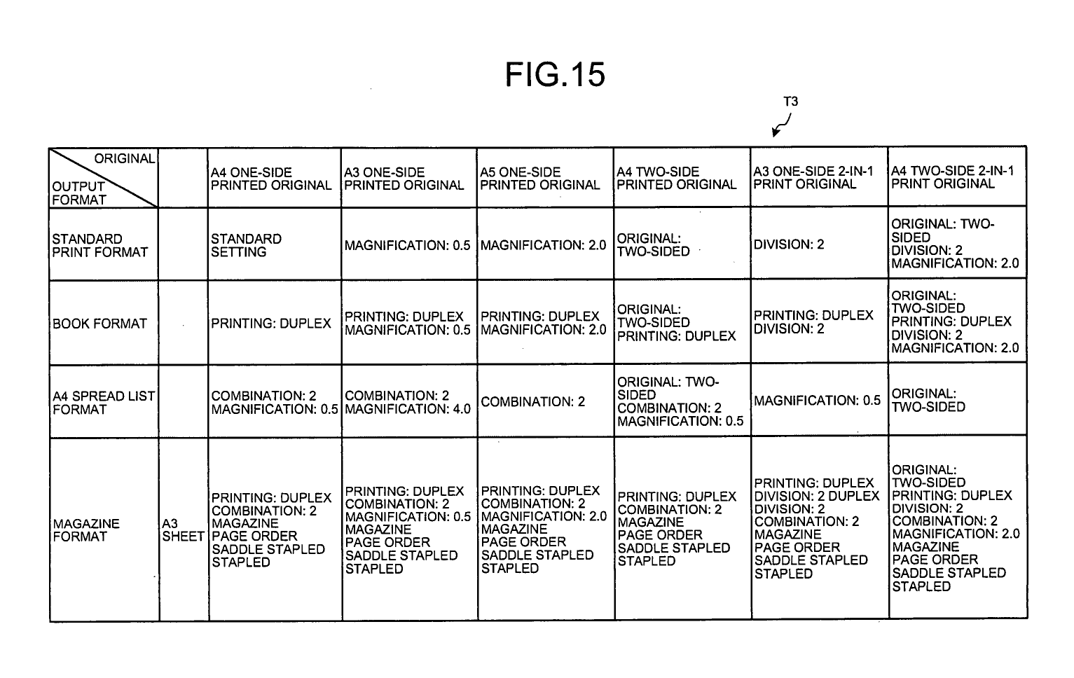

At step S28, the system control unit 16 obtains image processing setting items (VS) from the image analysis information and the output format selected by the user using, for example, a conversion table T3 as shown in FIG. 15. In the conversion table shown in FIG. 15, an output format selected by the user and an original format are associated with each other. For example, when image data is of A3 one-side printed original and the user selects the book format, printing is set to “duplex” and magnification is set to “0.5”.

The system control unit 16 passes the obtained image processing setting items (VS) to the image processing unit 13 together with image data of a necessary number of pages (step S29).

The image processing unit 13 applies processing to the image data based on the image processing setting items (VS) so that the image data corresponds to the output format selected by the user, and passes a result of the processing to the storage unit 12 (step S30).

At step S31, the preview creating unit 131 creates a preview image corresponding to the image data processed by the image processing unit 13 and stored in the storage unit 12. The screen-information generating unit 132 generates input screen information from the preview image and the image processing setting items (VS). The display control unit 151 displays the input screen information on the display panel 15b.

The user checks whether the setting satisfies his/her requirement while viewing the preview image 401. When the user desires to add or change a setting item, the user provides an instruction for the change from the setting items 402. According to the instruction (Yes at step S32), the system control unit 16 repeats the processing at steps S27 to S31. In other words, when additional setting is input by the user, the system control unit 16 updates the image processing setting item (VS) 410. The preview image 401 is created and displayed again.

On the other hand, when there is no such instruction and the start key (not shown) of the display unit 15 is operated (Yes at step S33), the printer controller 142 controls the printer 14 to print the processed image based on specified settings (step S34).

When the print output is finished, the system control unit 16 clears the data and the setting items stored in the storage unit 12 (step S35).

As described above, according to the second embodiment, with respect to image data obtained from a set of originals in a plurality of formats, image analysis information is generated based on the feature of the image data extracted therefrom. The image data of the set of originals are unified into a selected output format based on the image analysis information. A preview image is created from the image data in the output format and is displayed. The image data are output depending on content of the preview image. Consequently, even when a set of originals includes those in a plurality of formats (image data in a plurality of formats), it is possible to obtain an output in a desired format by only selecting a desired output format.

In the embodiments described above, the image data of the originals 50 is acquired by the scanner 11. However, the image data can be acquired through the network 18 such as a public network for facsimile communication via the communication control unit 17. Besides, the image can be output through the network 18 such as a public network for facsimile communication as well as being output to a sheet. In other words, the image data or the image can be received from and output to any media available for the MFP 10.

By the facsimile function of the MFP 10, transmission of a set of originals in a plurality of formats requires adjustment of the output format, and thus is very complicated. For example, to create originals for transmission, documents in different sizes are copied on sheets of the same size, bound documents are copied page by page, or one-side printed originals and two-side printed originals are unified into either one of the output formats to be copied. However, according to the second embodiment, even for a set of originals in a plurality of formats, it is possible to adjust an input/output format.

A transmission destination through the network 18 is not limited to a facsimile machine and can be those storing and managing image data such as a server. In particular, such a server can transmit image data in a standard format, which is advantageous for management and reuse of image data.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
an input unit that receives image data of a set of originals in a plurality of formats;
an analyzing unit that analyzes the image data to extract a feature of the image data, and generates analysis information for the image data based on the feature;
a format display unit that selectably displays output formats for the image data;
a selecting unit that allows selection of one of the output formats;
an adjusting unit that adjusts, based on the analysis information, the formats of the image data into a uniform output format selected by the selecting unit;
a preview creating unit that creates a preview image from the image data in the uniform output format;
a preview display unit that displays the preview image; and
an output unit that outputs, depending on content of the preview image, the image data in the uniform output format.

2. The image processing apparatus according to claim 1, wherein
a setting item is determined based on the feature to adjust the image data to a reference format for adjusting the image data to the uniform output format,
the image data is managed in order in which the image data is adjusted to the reference format,
the analysis information associates the setting item with the image data, and
the adjusting unit adjusts the image data in the reference format to the uniform output format with a processing setting item obtained from the setting item for adjusting the image data to the reference format based on the analysis information and a setting item for the uniform output format from the reference format.

3. The image processing apparatus according to claim 1, wherein
the image data is managed in order in which the image data is received,
the analysis information associates the feature with the image data, and
the adjusting unit adjusts the image data to the uniform output format with a processing setting item obtained from the analysis information and the uniform output format.

4. The image processing apparatus according to claim 1, further comprising a setting unit that receives input of setting for the preview image, wherein
the preview creating unit updates the preview image based on the setting.

5. The image processing apparatus according to claim 2, wherein the preview display unit displays the processing setting item together with the preview image.

6. The image processing apparatus according to claim 5, wherein the preview display unit displays the setting item for adjusting the image data to the reference format together with the preview image.

7. The image processing apparatus according to claim 1, further comprising an adding unit that additionally registers an output format to be displayed by the format display unit.

8. A computer program product comprising a computer usable medium having computer readable program codes embodied in the medium that, when executed, causes a computer to execute:
receiving image data of a set of originals in a plurality of formats;
analyzing the image data to extract a feature of the image data, and generating analysis information for the image data based on the feature;
selectably displaying output formats for the image data;
selecting one of the output formats;
adjusting, based on the analysis information, the formats of the image data into a uniform output format selected at the selecting;
creating a preview image from the image data in the uniform output format;
displaying the preview image; and
outputting, depending on content of the preview image, the image data in the uniform output format.

9. The computer program product according to claim 8, further causing the computer to execute:
determining a setting item based on the feature to adjust the image data to a reference format for adjusting the image data to the uniform output format; and
managing the image data in order in which the image data is adjusted to the reference format, wherein
the analysis information associates the setting item with the image data, and
the adjusting includes adjusting the image data in the reference format to the uniform output format with a processing setting item obtained from the setting item for adjusting the image data to the reference format based on the analysis information and a setting item for the uniform output format from the reference format.

10. The computer program product according to claim 8, further causing the computer to execute managing the image data in order in which the image data is received, wherein
the analysis information associates the feature with the image data, and
the adjusting includes adjusting the image data to the uniform output format with a processing setting item obtained from the analysis information and the uniform output format.

11. The computer program product according to claim 8, further causing the computer to execute receiving input of setting for the preview image, wherein
the creating includes updating the preview image based on the setting.

12. The computer program product according to claim 9, wherein the displaying includes displaying the processing setting item together with the preview image.

13. The computer program product according to claim 12, wherein the displaying includes displaying the setting item for adjusting the image data to the reference format together with the preview image.

14. The computer program product according to claim 8, further causing the computer to execute additionally registering an output format to be displayed.

15. An image processing method comprising:
receiving image data of a set of originals in a plurality of formats;
analyzing the image data to extract a feature of the image data, and generating analysis information for the image data based on the feature;
selectably displaying output formats for the image data;
selecting one of the output formats;
adjusting, based on the analysis information, the formats of the image data into a uniform output format selected at the selecting;
creating a preview image from the image data in the uniform output format;
displaying the preview image; and
outputting, depending on content of the preview image, the image data in the uniform output format.
